(19) United States
(12) Patent Application Publication
(10) Pub. No.: US 2004/0113629 A1
(43) Pub. Date: Jun. 17, 2004

(54) Energy store and method for determining the wear to an electrochemical energy store

(76) Inventors: Helmut Laig-Hoerstebrock, Frankfurt (DE); Eberhard Meissner, Wunstorf (DE)

Correspondence Address: FOLEY & LARDNER, 777 EAST WISCONSIN AVENUE, SUITE 3800, MILWAUKEE, WI, 53202-5308, US

(21) Appl. No.: 10/626,980

(22) Filed: Jul. 25, 2003

(30) Foreign Application Priority Data
Jul. 26, 2002 (DE) DE102 34 032.3-34

(51) Int. Cl. G01N 27/416

(52) U.S. Cl. 324/431

(57) ABSTRACT

A method for determining the wear to an electrochemical energy store includes determining the temperature of a battery and determining a wear variable over time as a function of the battery temperature. The wear variable is determined as a sum of temperature-dependent wear contributions over time, with the values of the wear contributions rising more than proportionally as the battery temperature rises. An energy store such as a battery or a system provided with an energy store includes a temperature measurement device or means and a computation device or means configured to calculate a wear variable in accordance with the method.

### CROSS-REFERENCE TO RELATED PATENT APPLICATIONS

German Priority Application DE 102 34 032.3-34, filed Jul. 26, 2002 including the specification, claims, and abstract, is incorporated herein by reference in its entirety.

### BACKGROUND OF THE INVENTION

The present invention relates to a method for determining the wear to an electrochemical energy store by determining the temperature and determining a wear variable over time as a function of the battery temperature. The present invention also relates to an energy store, in particular a storage battery for motor vehicles, having temperature measurement means and having computation means, and to a system which is provided with an electrochemical energy store.

Energy stores, for example rechargeable electrochemical storage batteries, are subject to wear, in particular during discharging and charging. In addition to discharging and charging, there are also other operating conditions which speed up the wear of electrochemical energy stores. In the case of a lead-acid rechargeable battery, for example, these include the overall operating time, that is to say, the total time which has passed since it was first used, including the periods in which the rechargeable battery had no electrical load applied to it.

Furthermore, increased temperatures can exacerbate the wear during the periods when no electrical load is applied, as well as the wear caused by cyclic discharging and charging.

For the use of energy stores, it is desirable to determine the wear on the basis of the loss of storage capacity. In this case, however, the complexity of the processes in the energy store represents a problem which can be described only with difficulty by scientific methods.

For example, DE 38 08 559 C2 discloses a method for monitoring the power limit of a starter battery, in which an amount of charge balance is produced by adding up the amount of charge which has flowed in and flowed out. The state of charge of the starter battery is assessed from this, in conjunction with monitoring of a terminal voltage limit and the temperature. No statement can be made about the remaining maximum storage capacity of the energy store.

DE 195 40 872 C2 describes an empirical method for determining the aging state of a battery, in which a battery-specific family of characteristics for battery aging is predetermined. A battery aging value is determined with the aid of a family of characteristics by recording instantaneous values of battery aging influencing variables for the monitored battery. This includes, inter alia, a coefficient to take account of the temperature influence.

DE 195 40 827 A1 describes a method for determining the aging state of a battery, in which aging components which have been determined are added up to form a battery aging value. The aging components are determined on the basis of a predetermined family of characteristics and continuous measurement value monitoring on the battery. The aging components are dependent, for example, on the characteristic amount of charge discharged in each discharge cycle, the remaining amount of charge, the rate of charging or discharging, and the temperature influence.

It is known from DE 44 1 4 1 34 A1 that the battery temperature has a major influence on the battery life, and that there is an exponential relationship between the temperature and the battery life.

U.S. Pat. No. 6,369,578 B1 describes a method for determining the state of a vehicle starter battery, in which a state value is determined from the difference between a preceding state value and a wear contribution. The wear contribution is determined from a table as a function of the maximum temperature and the minimum state of charge in the interval between a preceding starting process and a subsequent starting process. The wear contributions are in this case defined such that they increase more than proportionally as the temperature rises, and also increase more than proportionally as the state of charge decreases. A wear contribution is determined for each starting process, although this does not depend on the time period since the last starting process.

Accordingly, there is a need for a method for determining the wear to an electrochemical energy store utilizing battery temperature and a wear variable that is a function of the battery temperature. There is also a need for a system and/or an energy store that incorporates such a method.

### SUMMARY OF THE INVENTION

An exemplary embodiment relates to a method for determining the wear to a battery. The method includes determining the battery temperature of a battery and determining a wear variable over time as a function of the battery temperature. The wear variable is determined as a sum of temperature-dependent wear contributions over time, with the values of the wear contributions rising more than proportionally as the battery temperature rises.

Another exemplary embodiment relates to a storage battery for motor vehicles. The storage battery includes temperature measurement means and computation means for calculating a wear variable of the storage battery. The computation means is configured to calculate the wear variable as a function of measured battery temperature using a method comprising that includes determining the temperature of a battery and determining a wear variable over time as a function of the battery temperature. The wear variable is determined as a sum of temperature-dependent wear contributions over time, with the values of the wear contributions rising more than proportionally as the battery temperature rises.

Another exemplary embodiment relates to a system provided with an electrochemical energy store. The system includes a temperature measurement device and a computation device. The computation device calculates a wear variable as a function of measured battery temperature according to a method that includes determining the temperature of a battery and determining a wear variable over time as a function of the battery temperature. The wear variable is determined as a sum of temperature-dependent wear contributions over time, with the values of the wear contributions rising more than proportionally as the battery temperature rises.

### DETAILED DESCRIPTION OF THE PREFERRED EMBODIMENTS

According to a preferred embodiment, the wear of an electrochemical energy store is determined directly from a measurement of battery temperature over time, with differentiation being carried out on the basis of temperature bands. In this case, it has been found that the wear of the energy store proceeds progressively as the temperature rises above an upper limit temperature and, without any further influencing variables, the wear can be calculated directly from the temperature of the energy store.

The battery temperature can be determined relatively easily by measurement, estimation or calculation, by derivation from the known temperatures of other components, by taking into account the heat introduced and emitted by radiation or the flow of fluids, by taking account of the heat introduced by electrical power losses in the energy store, etc.

It is also possible to take account of the fact that a wear variable increases linearly with time, independently of the battery temperature over time, at battery temperatures in an intermediate range between a lower limit temperature and the upper limit temperature. Furthermore, no wear generally occurs below the lower limit temperature, so that the wear variable which was determined prior to this will remain constant in this temperature band.

In order to determine the wear variable Qᵥ, wear contributions qᵥ are preferably calculated in time intervals dt, with the time intervals dt preferably in each case being of such a duration as a function of the battery function T that the battery temperature is constant in defined tolerance bands. In the case of the procedure which is differentiated on the basis of temperature bands, the time bands are, however, defined on the basis of the temperature intervals mentioned above. The wear variable Qᵥ is then determined as the sum of the wear contributions qᵥ in successive time intervals dt.

For battery temperatures above an upper limit temperature, the wear contributions qᵥ may increase progressively over time with the battery temperature. For battery temperatures in the intermediate range above the lower limit temperatures and below the upper limit temperatures, the wear contributions qᵥ may increase linearly with time independently of the temperature, and the wear contributions qᵥ may remain constant for battery temperatures below the lower limit temperature.

The temperature dependency of the wear contributions qᵥ may have widely differing forms, depending on the battery system. One approach that may be used is:

qᵥ=K₀ * c * exp(−E/T)dt

where the wear variable Qᵥ is calculated from the wear contributions qᵥ in accordance with the formula:

Qᵥ=Σqᵥ

and where K₀ is a proportionality factor which advantageously reflects the capacity of the energy store, and c is a dimensionless factor. The variable E indicates an activation temperature with the dimension degrees.

It is also possible to represent the temperature dependency on the wear contributions qᵥ in a simplified form, for example by differentiation of the temperature bands, with at least one of the temperature bands having a more than proportional temperature dependency. By way of example, the temperature-dependent wear contributions qᵥ subdivided on the basis of temperature bands can be calculated in accordance with the formulae:

$$\begin{matrix}\begin{matrix}{q}_{v} = {K}_{0} * A * ( 1 + a * T + b * {T}^{2} ) ⅆ t \\ for T \geq {T}_{0}\end{matrix} \\ \begin{matrix}{q}_{v} = {K}_{0} * B * ( T - {T}_{1} ) ⅆ t \\ for {T}_{1} < T < {T}_{0}\end{matrix} \\ \begin{matrix}{q}_{v} = 0 \\ for T \leq {T}_{1}\end{matrix}\end{matrix}$$

where the coefficient K₀ is a proportionality factor which advantageously reflects the capacity of the energy store. The coefficients A and B are proportionality factors, which may be chosen differently for different temperature bands. The variables in the equations are the battery temperature T in Kelvin [K] and the time t in hours [h].

The parameters A, B, a, b have the following dimensions:

A [h⁻¹], a [degrees⁻¹], b [degrees⁻²], B [degrees⁻¹/h]. The limit temperatures T₁ and T₀ are measured in Kelvin [K].

Different wear mechanisms frequently occur in the temperature bands. The constants c and E and A, B, a, b may therefore have different values in different temperature bands.

The storage capacity of the electrochemical energy store can advantageously be determined from a wear variable Qᵥ determined in this way by relating the wear variable Qᵥ to the storage capacity Q_{N} of the energy store at an earlier time than the time which is applicable to the wear variable Qᵥ. The storage capacity of the energy store in the new state, that is to say the initial capacity of the energy store, is preferably chosen as the reference.

The present storage capacity of the electrochemical energy store can then be determined from the difference between the initial capacity of the energy store in the new state and the wear variable.

The present storage capacity can therefore be determined relatively reliably with little computational effort and by simple continuous temperature measurement.

It is particularly advantageous to link the calculated wear variable to further state variables which describe the state of the energy store, and to determine a linked wear variable Qᵥ from this. The further state variables may be determined using one or more different methods for determining the wear to an electrochemical energy store. Methods are preferably used which take account of other effects that contribute to the wear of electrochemical energy stores than the temperature dependency of the time-dependent wear. A measure for the present storage capacity can be calculated by subtraction of the linked wear variable from the initial capacity of the electrochemical energy store.

According to an exemplary embodiment, an energy store includes a computation means or device for calculation of the wear variable as a function of the measured battery temperature on the basis of the method described above, for example by suitable programming of a microprocessor or microcontroller system. According to another exemplary embodiment, a system is provided or equipped with an electrochemical energy store, in which a computation means or device is provided for calculation of the wear variable as a function of the measured battery temperature on the basis of the method described above, for example by suitable programming of a microprocessor or microcontroller system.

The present invention will be explained in more detail in the following text with reference to various exemplary embodiments.

A differential wear contribution qᵥ is determined as a function of the present battery temperature T. A wear variable Qᵥ, which is the time integral of the differential wear contributions qᵥ, is determined by adding up or summing the wear contributions qᵥ. Linked to the capacity of the storage battery in the new state, this wear variable Qᵥ is a measure of the storage capacity of the energy store.

### EXAMPLE 1

It has been found that wear which increases progressively as the battery temperature T rises can be observed at relatively high battery temperatures T above an upper limit temperature T₀ in a time interval dt of a specific duration. For medium battery temperatures T below the upper limit temperature T₀ and above a lower limit temperature T₁, the wear in a time interval dt with a specific duration is linearly dependent on the temperature, and increases linearly as the time passes. No significant wear occurs at low battery temperature T below the lower limit temperature T₁.

The wear to an electrochemical energy store is thus determined differentiated on the basis of the stated temperature bands. For time intervals dt in which the temperatures T are approximately the same within a tolerance band, wear contributions qᵥ are calculated in accordance with the following formulae:

$$\begin{matrix}\begin{matrix}{q}_{v} = {K}_{0} * A * ( 1 + a * T + b * {T}^{2} ) ⅆ t \\ for T \geq {T}_{0}\end{matrix} \\ \begin{matrix}{q}_{v} = {K}_{0} * B ( T - {T}_{1} ) ⅆ t \\ for {T}_{1} < T < {T}_{0}\end{matrix} \\ \begin{matrix}{q}_{v} = 0 \\ for T \leq {T}_{1} .\end{matrix}\end{matrix}$$

In this case, K₀ is a proportionality factor which advantageously reflects the battery size, the battery capacity and similar features, and which may be chosen differently for the different temperature bands. However, the proportionality factor K₀ is preferably chosen to be equal to the storage capacity Q_{N} of the energy store in the new state, for all temperatures. The proportionality factor K₀ then corresponds to the initial capacity of the energy store.

The time parameter A, which may assume different values for different temperature bands, has the dimension h⁻¹. The first temperature coefficient a has the dimension degrees⁻¹, the second temperature coefficient b has the dimension degrees⁻². B is a time temperature parameter with the dimension degrees⁻¹/h. The limit temperatures T₁ and T₀ are measured in K. The variables in the equations mentioned above are the temperature T in ° C. and the time t in hours [h]. The temperature of the energy store can be measured directly on the energy store, or can be estimated or calculated from other variables. The battery temperature T can be derived from known temperatures of other components. The amount of heat introduced and emitted by radiation or the flow of fluids can also be taken into account, or the amount of heat introduced by electrical power losses in the energy store can be taken into account. Further methods for determining a battery temperature T can be used equally well.

It has now been found that the wear variable Qᵥ calculated from the sum of the wear contributions qᵥ expresses the loss of storage capacity of an electrochemical energy store. The present storage capacity can thus be determined from the wear variable Qᵥ by relating the wear variable Qᵥ to the storage capacity Q_{N} of the energy store at an earlier time, for example by relating it to the initial capacity of the energy store in the new state. The wear variable Qᵥ is preferably set to the value zero at this time. The present storage capacity of the energy store can thus be determined by simple temperature measurements and with little computation effort by continuously determining the wear variable Qᵥ, starting from the new state, throughout the entire operation of an energy store. This is done simply by calculating the difference between the wear variable Qᵥ and the storage capacity Q_{N} of the energy store at an earlier time, preferably the initial capacity in the new state.

The following parameter and coefficient values have been found to be advantageous for a lead-acid rechargeable battery:

Time parameter A=2.8·10⁻⁵ [h⁻¹]

First temperature coefficient a=5.7·1 0⁻²[degrees⁻¹]

Second temperature coefficient b=1.1·10⁻³[degrees⁻²]

Time temperature parameter B=2.7·10⁻⁷[degrees]

Lower limit temperature T₁=0° C.=273 K

Upper limit temperature T₀=25° C.=298 K.

### EXAMPLE 2

If the wear contributions qᵥ are described by the exponential function described above, it has been found, for example, for a lead-acid rechargeable battery, that the constants c=123 and E=5000 degrees represent a good guideline value for the wear, so that this results in a wear contribution of qᵥ=132 * K₀[Ah] * exp (−5000/T) as the loss per hour [h] in [Ah/h]. If a temperature profile on the storage battery throughout the day is, for example assumed to be 25° C. for 22 hours and 60° C. for 2 hours, then the ratio of the wear variable Qᵥ to the proportionality factor Qᵥ/K₀ becomes 8.4% per annum.

Since, apart from the temperature influence, there are also other aspects which contribute to the wear of electrochemical energy stores, such as the rate of chargeable discharge, it is advantageous to link the wear variable Qᵥ to further state variables which have been determined using other methods for determining the wear, in particular methods which take account of effects other than the temperature influence which contribute to the wear.

It is important to note that the construction and arrangement of the elements of the energy store as shown and described in the preferred and other exemplary embodiments is illustrative only. Although only a few embodiments of the present inventions have been described in detail in this disclosure, those skilled in the art who review this disclosure will readily appreciate that many modifications are possible without materially departing from the novel teachings and advantages of the subject matter recited herein. It should be noted that the elements and/or assemblies of the system may be constructed from any of a wide variety of materials that provide sufficient strength or durability. Other substitutions, modifications, changes and omissions may be made in the design, operating conditions and arrangement of the preferred and other exemplary embodiments without departing from the scope of the present invention.

What is claimed is:

1. A method for determining the wear to a battery comprising:
determining the temperature of a battery; and
determining a wear variable over time as a function of the battery temperature;
wherein the wear variable is determined as a sum of temperature-dependent wear contributions over time, with the values of the wear contributions rising more than proportionally as the battery temperature rises.

2. The method of claim 1 wherein the wear variable is dependent on the battery temperature in accordance with the formula
Qᵥ=K₀ * c * exp(−E/T)dt
where T is a value which corresponds approximately to the battery temperature, K₀ is a defined proportionality factor, c and E are defined constants, and dt is a time interval.

3. The method of claim 1 wherein the dependency of the wear variable on the battery temperature is differentiated on the basis of temperature bands.

4. The method of claim 1 wherein the wear variable increases linearly with the battery temperature over time and linearly with time for battery temperatures between a lower limit temperature and an upper limit temperature.

5. The method of claim 4 wherein the wear variable remains constant over time for a battery temperature below the lower limit temperature.

6. The method of claim 1 further comprising calculating wear contributions in time intervals, with the wear contributions increasing more than proportionally with the battery temperature for battery temperatures above an upper limit temperature.

7. The method of claim 6 wherein the wear contributions for battery temperatures above the upper limit temperature are calculated in accordance with the formula:
qᵥ=K₀ * A * (1+a * T+b * T²)dt,
where K₀ is a proportionality factor, A is a time parameter, a is a first temperature coefficient and b is a second temperature coefficient.

8. The method of claim 7 wherein the wear contributions for battery temperatures below the upper limit temperature are calculated in accordance with the formula
qᵥ=K₀ * B(T−T₁)i dt,
where K₀ is a proportionality factor and B is a time parameter.

9. The method of claim 7 wherein the wear contributions for battery temperatures above a lower limit temperature and below the upper limit temperature are calculated in accordance with the formula
qᵥ=K₀ * B(T−T₁)dt,
where K₀ is a proportionality factor and B is a time parameter, and the wear contributions for battery temperatures below the lower limit temperature are equal to zero.

10. The method of claim 6 wherein the wear contributions are calculated in time intervals, with the time intervals each being of such a size as a function of the battery temperature that the battery temperature is approximately constant.

11. The method of claim 1 wherein the battery has a storage capacity and the wear variable is a measure of the storage capacity of the battery, with the wear variable being related to the storage capacity of the battery at an earlier time than the time which is applicable to the wear variable.

12. The method of claim 11 wherein the storage capacity of the battery relating to the earlier time is an initial capacity of the battery in a new state.

13. The method of claim 12 wherein the wear variable relating to the earlier time is zero.

14. The method of claim 11 further comprising calculating a present storage capacity of the battery from the difference between an initial capacity of the battery in a new state and the wear variable.

15. The method of claim 1 further comprising determining a linked wear variable from the wear variable and further state variables which describe a state of the battery.

16. A storage battery for motor vehicles comprising:
temperature measurement means; and
computation means for calculating a wear variable of the storage battery;
wherein the computation means is configured to calculate the wear variable as a function of measured battery temperature using a method comprising:
determining the temperature of a battery; and
determining a wear variable over time as a function of the battery temperature;
wherein the wear variable is determined as a sum of temperature-dependent wear contributions over time, with the values of the wear contributions rising more than proportionally as the battery temperature rises.

17. A system provided with an electrochemical energy store comprising:
a temperature measurement device; and
a computation device;
wherein the computation device calculates a wear variable as a function of measured battery temperature according to a method comprising:
determining the temperature of a battery; and
determining a wear variable over time as a function of the battery temperature;
wherein the wear variable is determined as a sum of temperature-dependent wear contributions over time, with the values of the wear contributions rising more than proportionally as the battery temperature rises.
